(19) United States
(12) Patent Application Publication
(10) Pub. No.: US 2012/0244487 A1
(43) Pub. Date: Sep. 27, 2012

(54) Head Positioning Instrument

(76) Inventors: Ryan Tamburrino, Ardmore, PA (US); Ken Tamburrino, Aliquippa, PA (US)

(21) Appl. No.: 13/070,455

(22) Filed: Mar. 23, 2011

(51) Int. Cl. A61C 7/00

(52) U.S. Cl. 433/7

(57) ABSTRACT

A head positioning instrument is provided for accurately modeling the position of a patient's jaw for orthodontic treatment planning. The horizontal distance between a pair of reference points that are visible on an x-ray are measured. These reference points are then utilized to ensure that substantially true vertical and substantially true horizontal are reflected in a radiograph. The patient's lower jaw hinge is accurately located, and the upper jaw is located using a bite fork attached to the lower jaw hinge axis locator. The lower jaw hinge axis locator with the bite fork attached are removed from the head positioning instrument and transferred to an axis mounting stand for accurate reproduction. The patient's individual characteristics are accurately preserved throughout the transfer and modeling process, resulting in accurate correspondence between the model and radiograph.

### TECHNICAL FIELD

The present invention relates to the field of orthodontics. More specifically, a head positioning apparatus to assist an orthodontist in accurately modeling the characteristics of a patient's upper and lower jaw, as well as their position relative to the hinge of the lower jaw, is provided.

### BACKGROUND INFORMATION

When planning or executing dental, orthodontic, or orthognathic treatment, accurate positioning of the upper and lower jaw are critical to optimizing the aesthetics, function, and stability of the stomatognathic system. An error of even a fraction of a millimeter can mean the difference between success and failure. However, presently available modeling systems fail to provide this level of accuracy.

Traditional radiographs typically spread as they travel from their source, through the patient, and to the film, resulting in magnification and distortion of the resulting image. This magnification and distortion are eliminated by cone-beam computed tomography, allowing more accurate representation of a patient's current condition on the film. However, this technology does nothing to orient the image or represent true vertical and true horizontal on the radiograph, or to correspond the radiographic images to a model for use in planning treatment.

Facebows are presently used to assist in locating the position of the maxilla (upper jaw) to the hinge of the lower jaw. However, presently available estimated facebows do not actually locate the lower jaw hinge, but are instead designed estimate the hinge position relative to a patient's ear canal. When presently available facebows are used, the hinge for the lower jaw is estimated to be about 15 mm from the ear canal. The models of the upper and lower jaws are therefore positioned based on an estimate of their position relative to the hinge, rather than a measured position with respect to the hinge. This estimate may or may not be sufficiently accurate for planning a given treatment.

Accordingly, there is a need for a method of representing true vertical and true horizontal on an x-ray image of a patient's head. There is a further need for a more accurate method of locating the upper and lower jaw of an orthodontic patient with respect to the hinge of the lower jaw, and accurately transferring these positional relationships to a treatment planning model. Additionally, there is a need to provide accurate correspondence between an x-ray image of a patient and a treatment model of the patient in order to provide a means of accurate treatment planning.

### SUMMARY

The above-described needs are met by the head positioning instrument described herein. The head positioning instrument includes a pair of reference point locators that are structured to locate a pair of predetermined points which are selected to be easy to locate on an x-ray image, and provide a means to substantiate orientation of the radiographic image to substantially true vertical and substantially true horizontal.

The head positioning instrument may also include a lower jaw hinge locator that is structured to be placed adjacent to a lower jaw hinge of the patient. A maxillary bite fork is structured to be attached to the lower jaw hinge locator in a manner that permits vertical and horizontal adjustment of the bite fork's position with respect to the lower jaw hinge locator. The assembly of the lower jaw hinge locator and bite fork may be removed from the head positioning instrument for producing a model that accurately represents the position of the patient's upper jaw, lower jaw, and jaw hinge relative to each other.

These and other aspects of the invention will become more apparent through the following description and drawings.

### BRIEF DESCRIPTION OF THE DRAWINGS

FIG. 1 is a side perspective view of a frame for a head positioning instrument.

FIG. 2 is a top and side perspective view of a forehead locator for the head positioning instrument of FIG. 1.

FIG. 3 is a side perspective view of a tooth locator for the head positioning instrument of FIG. 1.

FIG. 4 is a top plan view of a facebow for the head positioning instrument of FIG. 1.

FIG. 5 is an exploded view of an adjustment arm and frame for a facebow of FIG. 5.

FIG. 6 is a perspective view of the assembled components of FIG. 5.

FIG. 7 is a top perspective view of a bite fork utilized with the head positioning instrument of FIG. 1.

FIG. 8 is a side perspective view of a calibration instrument for the head positioning instrument of FIG. 1.

FIG. 9 is a side elevational view of a forehead locator, facebow, and tooth locator for the head positioning instrument of FIG. 1.

FIG. 10 is an environmental, side perspective view of the head positioning instrument of FIG. 1, showing a predetermined point on the patient's forehead being located.

FIG. 11 is an environmental, side perspective view of the head positioning instrument of FIG. 1, showing the tip of the patient's front tooth being located.

FIG. 12 is an environmental, side perspective view of the head positioning instrument of FIG. 1, showing the hinge of the patient's lower jaw being located.

FIG. 13 is an environmental, side perspective view of the head positioning instrument of FIG. 1, showing the patient's upper jaw being located via a facebow with respect to the lower jaw's hinge.

FIG. 14 is an environmental, front, side, and top perspective view of a facebow and bite fork of the head positioning instruments of FIG. 1 mounted on an axis mounting stand.

FIG. 15 is an environmental, side perspective view of an upper jaw and lower jaw model mounted within an articulator.

Like reference characters denote like elements throughout the drawings.

### DETAILED DESCRIPTION

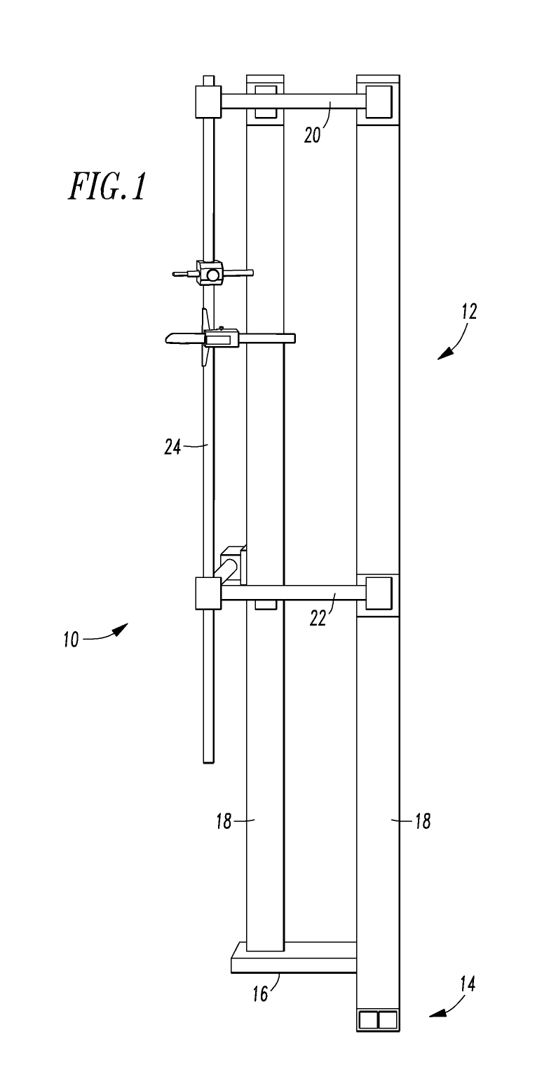

In the drawings, there is shown in example of a head positioning instrument. Referring to FIG. 1, a head positioning instrument 10 is shown. The head positioning instrument 10 includes a support frame 12 which in the illustrated example is structured to rest on a floor. The support frame 12 includes a base 14 having a plurality of feet 16. The feet 16 are adjustable so that the support frame may be oriented in a substantially vertical position, thereby keeping the various components of the head positioning instrument 10, described in greater detail below, oriented in a substantially horizontal position. Alternative support frames could be secured to a wall, or could depend downward from a ceiling. The support frame 10 includes three vertical members 18 extending upward from the base 14. The illustrated vertical members 18 are secured at their top ends by a top brace 20, and further secured together by an intermediate brace 22. Although the illustrated braces 20, 22 are triangular, other structures may be utilized. A substantially vertical rod 24 is held in position by the brace 12, and in the illustrated example is secured to the top support frame 20 at its upper end, and the intermediate support frame 22 in a lower portion of the rod 24. Alternative examples of the support frame 12 could potentially eliminate the vertical members 18 and braces 20, 22, and consist instead of a rod 24 and an alternative means to hold the rod 24 in a desired position relative to vertical.

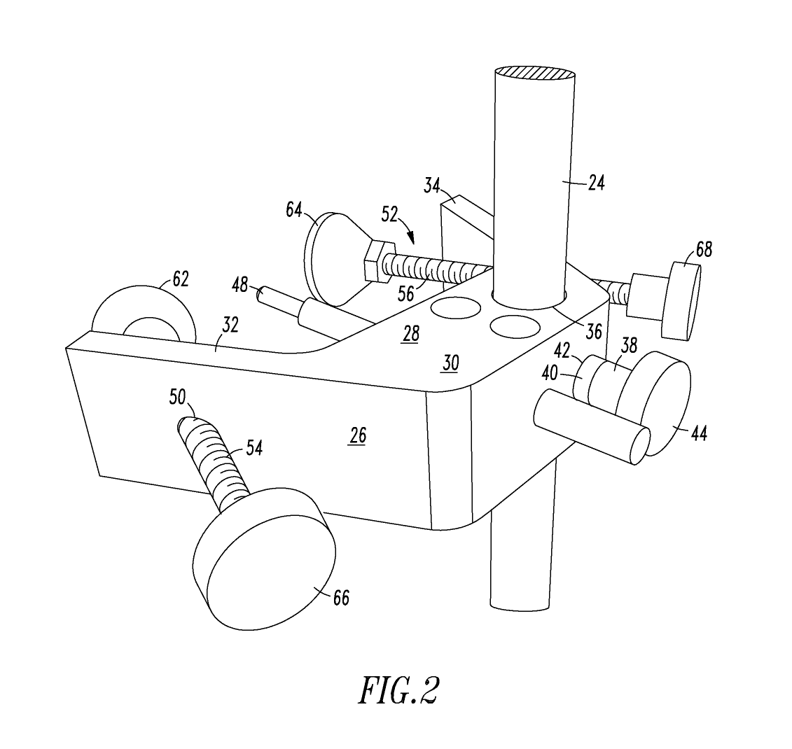

The head positioning instrument 10 includes a pair of reference point locators as well as a means for measuring at least a horizontal distance between the two reference point locators. In the illustrated example of a head positioning instrument 10, the two reference point locators consist of a forehead locator 26 and a tooth locator 70 (described below). Referring to FIG. 2, a forehead locator 26 is slidably mounted on the rod 24. The forehead locator 26 includes a main body 28, which in the illustrated example includes a central portion 30 having a pair of arms 32, 34 extending therefrom. The illustrated forehead locator 26 defines an aperture 36 that is structured to receive the rod 24. The forehead locator 26 includes a means of securing the forehead locator 26 in a desired position on the rod 24, which in the illustrated example includes a rod 38 having a threaded portion 40 is received within a threaded hole 42 that intersects with and is substantially perpendicular to the aperture 36. The opposite end of the rod 38 includes a knob 44 to facilitate turning of the threaded rod 38 so that it abuts the rod 24 and secures the forehead locator 26 in position, or is moved away from the rod 24 so that the forehead locator 26 maybe slid up and down the rod 24.

The forehead locator 26 includes a pointer 48, which is an elongated member extending outward from the central portion 30 of the forehead locator 26, terminating in a tip 48. One or more forehead rests may also be provided. The illustrated forehead locator 26 includes a pair of forehead rests 50, 52, each of which includes a threaded central rod 54, 56 passing through an aperture 58, 60 defined within the arms 32, 34, respectively, of the forehead locator 26. Each of the forehead rests 50, 52 includes a forehead stop 62, 64, respectively, on either side of the pointer 48. The opposite ends of the forehead rests 50, 52 includes a knob 66, 68, to facilitate turning the forehead rests 50, 52 to move the forehead stops 62, 64 towards or away from the patient's forehead.

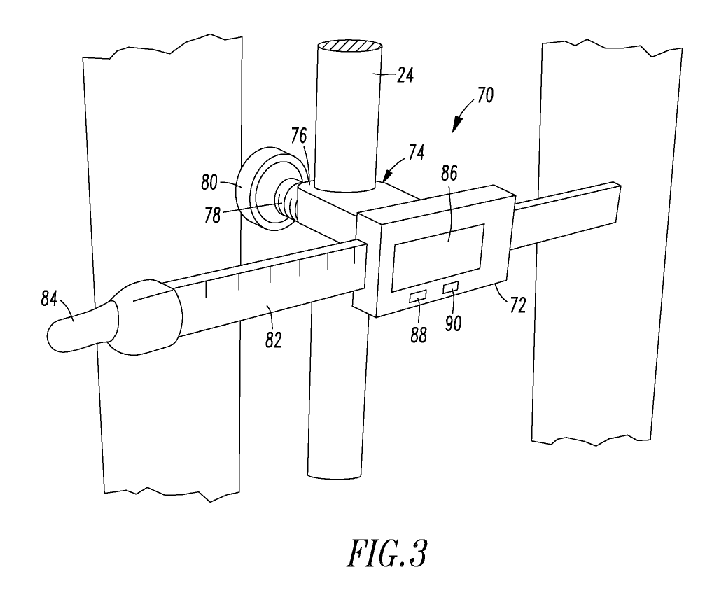

Referring to FIG. 3, a tooth locator 70 is illustrated. The tooth locator 70 includes a housing 72 having a clamp 74 secured to its back surface. The clamp 74 includes a ring 76 that is structured to fit around the rod 24. A threaded rod 78 engages a threaded aperture within the ring 76, permitting the threaded rod 78 to engage the rod 24 when the knob 80 disposed at the end of the threaded rod 78 is turned. The tooth locator 70 may therefore be moved vertically along the rod 24. The tooth locator 70 includes an elongated measuring member 82 having a tip 84 which may in some examples be covered with a disposable covering. The front of the housing 72 includes a display 86 which in the illustrated example is a liquid crystal display. The front of the housing 72 further includes an on/off button 88 and a zero button 90. The housing 72 includes an appropriate microcontroller to enable a desired zero position for the tip 84 to be set using the zero button 90, and for the horizontal distance of any positional changes of the tip 84 to be measured and displayed on the display 86, in a manner which is well known to those skilled in the art of depth gauges, digital calipers, etc.

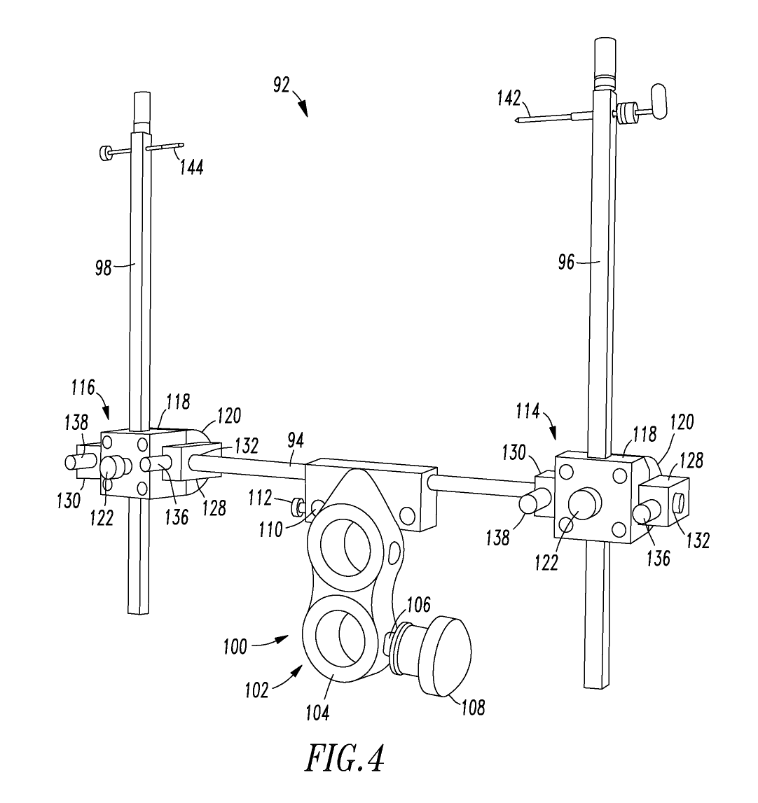

The head positioning instrument 10 includes a lower jaw hinge axis locator, which in some examples may be a hinge axis facebow. Referring to FIGS. 4-6, an example of a hinge-axis facebow 92 is illustrated. The hinge-axis facebow 92 includes a central member 94, and a pair of substantially parallel arms 96, 98 extending outward from each end of the central member 94. A clamp assembly 100 is centrally located on the central member 94. The clamp assembly 100 includes a clamp 102 including a ring 104 that is structured to fit around the rod 24 of the support frame 12. The ring 104 defines a threaded aperture therein for receiving a threaded rod 106 having a knob 108 disposed at one end. The facebow 92 may be moved vertically along the rod 24 by loosening the knob 108, and then secured in position by tightening the knob 108. In a similar manner, the clamp assembly 100 defines an aperture 110 that is structured to receive a bite fork (described below) therein. Similarly, a knob 112 is turned to bring a threaded rod into engagement with a bite fork within the aperture 110.

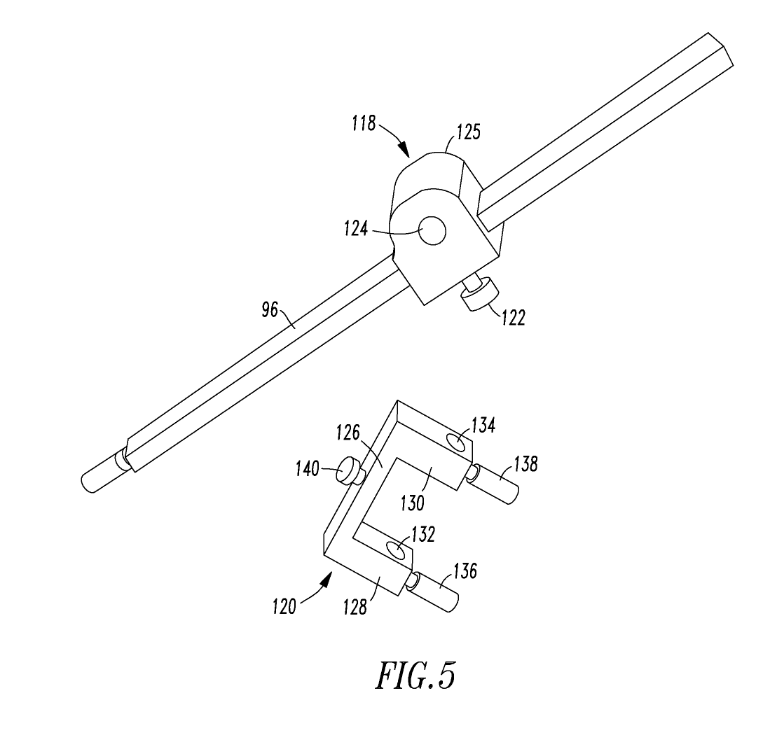

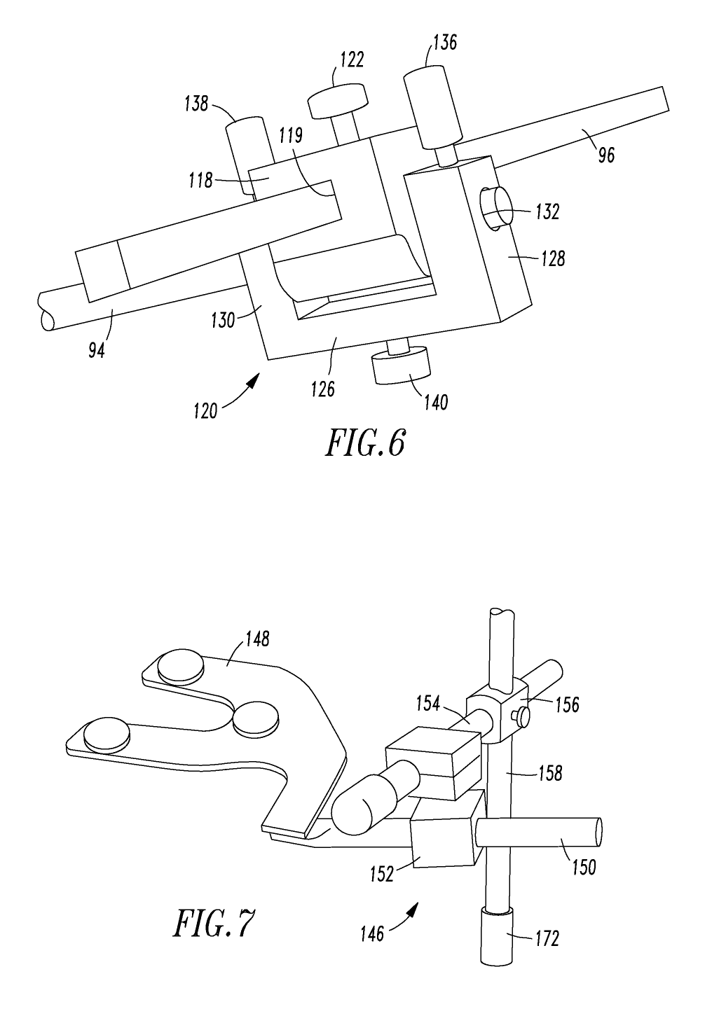

Each of the arms 96, 98 is secured to the central member 94 by a joint assembly 114, 116, respectively, that permits both longitudinal movement and angular pivoting of the arms 96, 98 with respect to the central member 94. Referring to FIGS. 5-6, the joint assemblies 114, 116, which are identical in the illustrated example, include a pivot block 118 and a U-shaped bracket 120. The pivot block 118 secures the arm 96 (or 98) within a channel 119 defined therein, and utilizes a thumbscrew 122 to secure the arm 96 or 98 in place. The arms 96, 98 may therefore be extended or retracted by loosening the thumbscrew 122, and then held in place by tightening the thumbscrew 122. A channel 124 defined within the pivot block 118 is substantially perpendicular to the arm 96, 98, and is structured to receive the central member 94. A generally semicircular outer surface 125 is disposed opposite the thumbscrew 122.

The U-shaped bracket 120 includes a central portion 126 and a pair of arms 128, 130. The arms 128, 130 define a channel 132, 134, respectively, therethrough for receiving the central member 94. A thumbscrew 136, 138 is utilized to secure the central member 94 within the channels 132, 134, respectively. Loosening the thumbscrews 136, 138 therefore permits the joint assembly 116 to the moved along or removed from the central member 96. Another thumbscrew 140 is disposed within the central portion 126. When the joint assemblies 114, 116 are positioned on the central member 94, the generally semicircular surface 125 is adjacent to the inner surface of the central portion 126 of the bracket 120. Loosening the thumbscrew 140 thereby permits pivoting of the arm 96, 98, and tightening the thumbscrew 140 secures the arm 96, 98 in a desired angular position.

The ends of the arms 96, 98 opposite the joint assemblies 114, 116 includes pointers 142, 144, respectively, each of which points towards the inside of the U-shape formed by the facebow 92. The pointers 142, 144 may in some examples be adjustable so that they extend a greater or lesser distance into the U-shape formed by the facebow and secured by a setscrew, a threaded connection, or other means that will be obvious to those skilled in the art.

Referring to FIG. 7, a bite fork 146 is illustrated. Suitable bite forks are available from various dental supply companies such as, for example, Panadent, Advanced Dental Designs, and SAM. The illustrated example of a bite fork 146 includes a substantially flat, generally U-shaped mouthpiece 148. A generally horizontal rod 150 extends outward from the mouthpiece 148, with the opposite end of the rod 150 being slidably secured within a clamping mechanism 152. The clamping mechanism 152 also slidably secures a second, generally horizontal rod 154 that is substantially perpendicular to the rod 150. A second clamping mechanism 156 is secured at the opposite end of the rod 154. A substantially vertical rod 158 is slidably secured within the clamping mechanism 156. The vertical rod 158 is structured to fit within the aperture 110 defined within the clamp assembly 100 of the facebow 90. By adjusting the position of the rods 150, 154, 158 within the clamps 152, 156, the position of the mouthpiece 148 with respect to the facebow 90 may be adjusted.

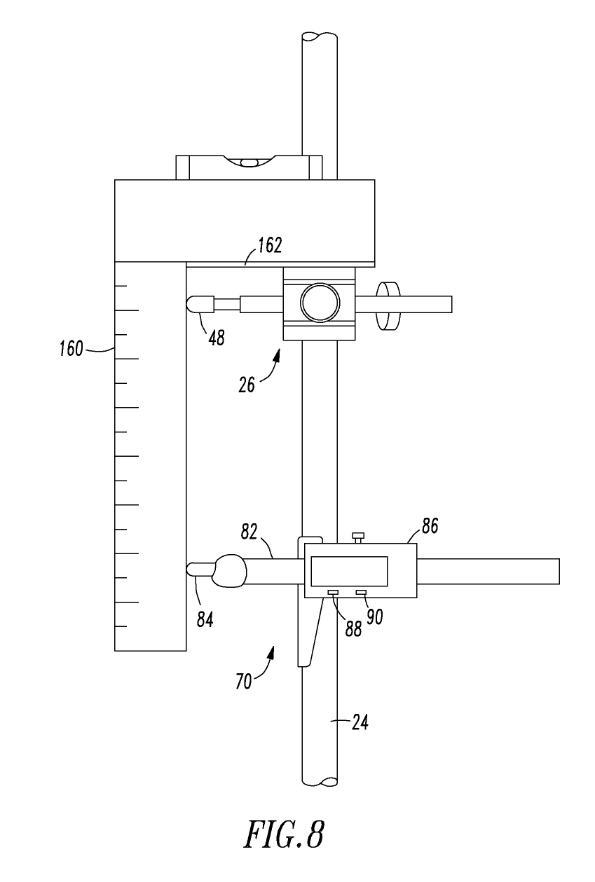

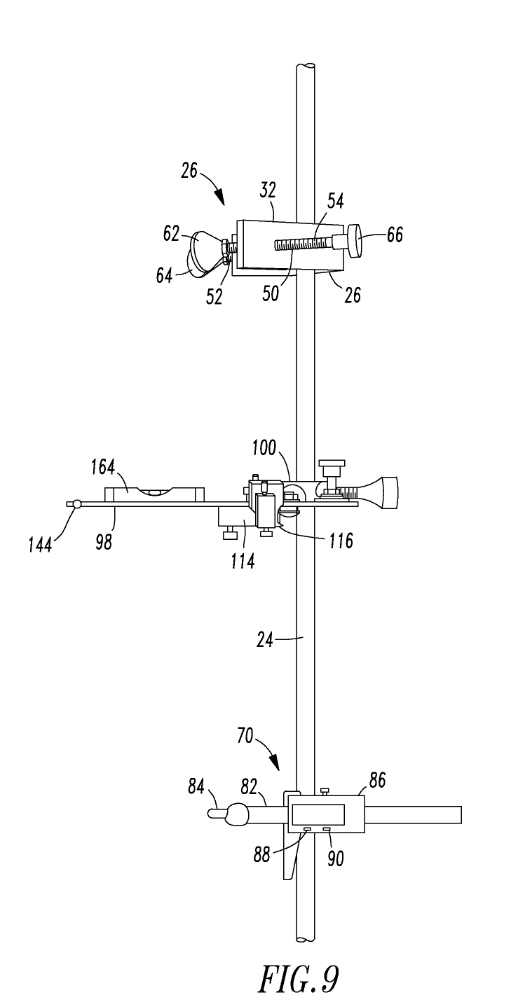

In use, if not already done, the feet 16 of the support base 12 (FIG. 1) are adjusted so that the rod 24 is a substantially vertical. Next, referring to FIG. 8, the tooth locator 70 is zeroed with respect to the forehead locator 26. To accomplish this, a tri-square 160 is placed against the tip 48 of the forehead locator, and optionally secured in this position by a magnet 162 disposed on top of the main body 28 of the forehead locator 26. The tooth locator 70 is adjusted so that the tip 84 is brought into contact with the tri-square 160. If not already done, the on/off button 88 is depressed to turn on the tooth locator 70. With the tip 84 in contact with the tri-square 160, the zero button 90 is depressed, thereby defining this position as zero horizontal distance with respect to the tip 48 of the forehead locator. The final setup step, shown in FIG. 9, is to ensure that the arms 96, 98 of the facebow 92 are substantially horizontal, utilizing a level 164 to determine the angular position of the arms 96, 98. If necessary, the thumbscrews 140 (FIGS. 4-6) may be loosened so that the pivot blocks 118 within the joint assemblies 114, 116 may be pivoted to bring the arms 96, 98 into a horizontal position. At this point, the thumbscrews 140 are both tightened to secure the arms 96, 98 in this position.

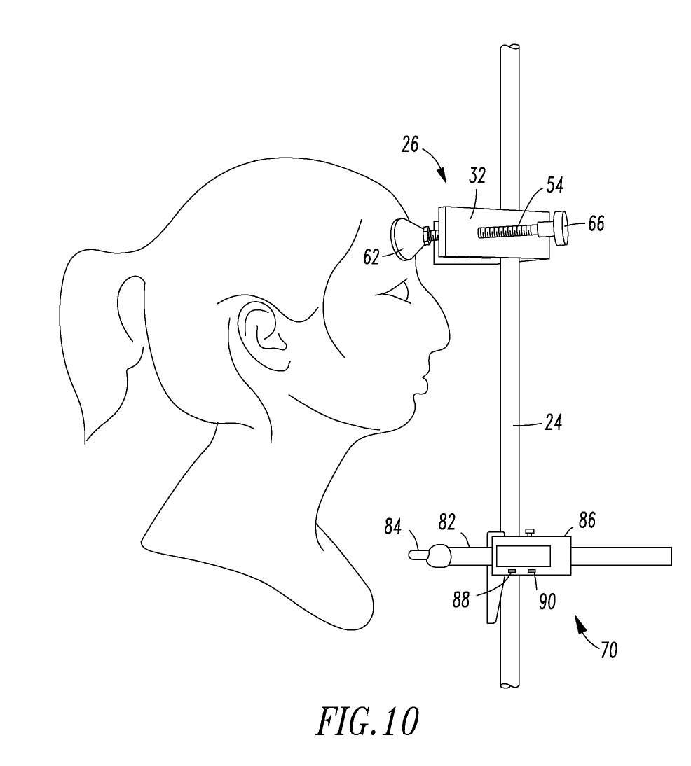

The initial step in locating the various features of a patient's jaw is to establish a predetermined point on the patient's forehead as a reference point, as illustrated in FIG. 10. A dot of barium paste or a metallic ball of approximately 1 mm diameter is placed on the patient's forehead. Either the barium paste or the metallic ball will easily be seen in an x-ray. The patient is asked to step forward towards the head positioning instrument 10, keeping their head in a substantially vertical position, so that the forehead locator 26 may be adjusted vertically along the rod 24 to bring the tip 48 into contact with the barium paste or metallic ball. The forehead rests 50, 52 are adjusted so that the patient may comfortably rest their head against the forehead rests 50, 52.

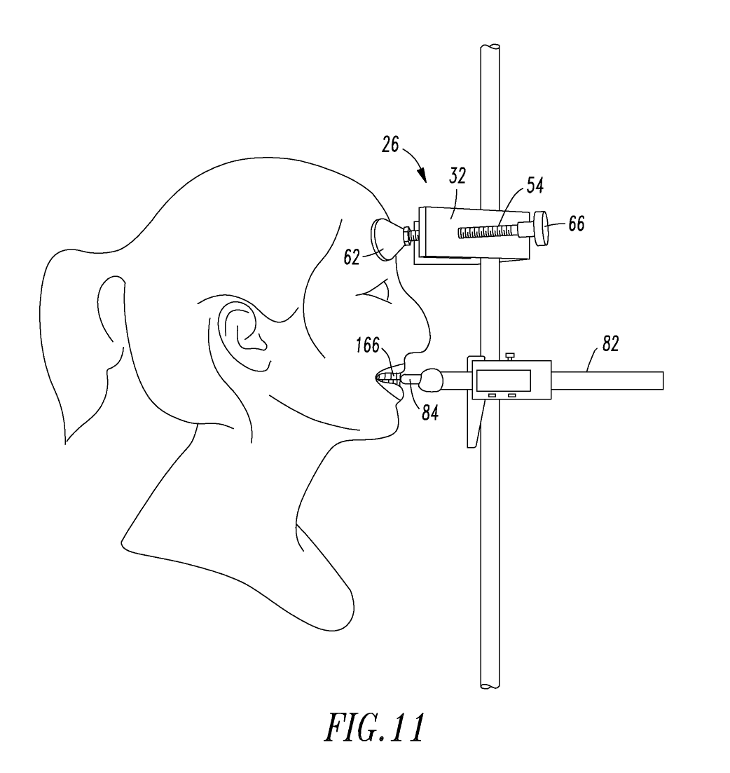

Next, referring to FIG. 11, the patient is asked to smile, and the tooth locator 70 is adjusted so that the tip 84 is positioned against the tip of the patient's upper front tooth 166. At this point, the horizontal distance between the predetermined point on the patient's forehead and the tip of the patient's upper front tooth 166 may be measured and recorded. Prior to or at this point, an x-ray of the patient may be taken. This x-ray may be taken using conventional radiography or using cone beam computed tomography. Cone beam computed tomography is preferred due to the minimal distortion of the radiographic image. Because both the predetermined position on the patient's forehead and the tip of the upper front tooth are clearly visible in the resulting x-ray, and because the support frame 12 has been positioned in a substantially vertical position, substantially true vertical and substantially true horizontal may be transferred and accurately represented on the x-ray image.

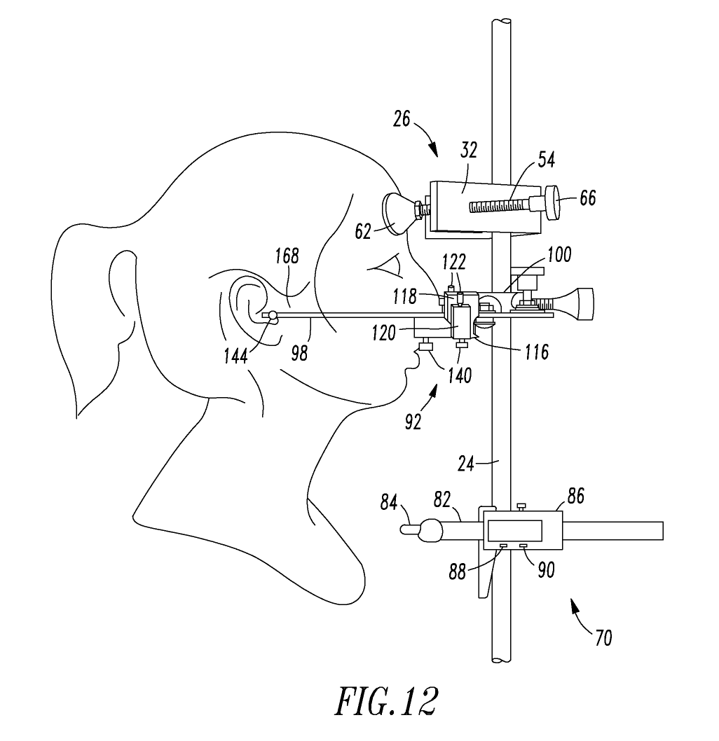

The hinge 168 of the lower jaw is located by using an axiographic recorder or estimated by palpation of the lateral portion of the condyle. Once this is located and recorded, as shown in FIG. 12, the facebow 92 is moved vertically along the rod 24 until the facebow 92 is in the same horizontal plane as the hinge 168. Next, this thumbscrews 122 are loosened so that the arms 96, 98 may be extended or retracted so that the pointers 142, 144 touch the hinge 168 of the lower jaw. At this point, the thumbscrews 122 are tightened.

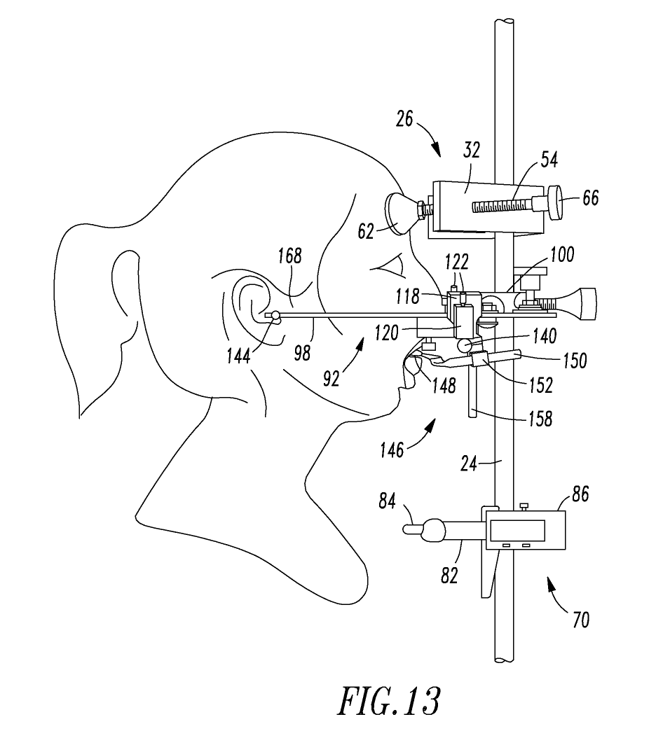

The location of the upper jaw with respect to the hinge 168 is determined as shown in FIG. 13. The upper and lower surfaces of the mouthpiece 148 of the bite fork 146 are covered with an impression compound that is known to those skilled in the art of orthodontics. The vertical rod 158 of the bite fork 146 is secured within the aperture 110 of the clamp assembly 100 of the facebow 92. The rods 150, 154 are adjusted within the clamping mechanism 152 to bring the mouthpiece 148 of the bite fork 146 into the proper three dimensional position within the patient's mouth. At this point, when the patient closes their mouth around the mouthpiece 148, the positions of the teeth within the upper jaw of the patient will be recorded within the impression compound. The position of the upper jaw relative to the hinge axis of the lower jaw 168 is now recorded in transferable form by the assembly of the facebow 92 and bite fork 146.

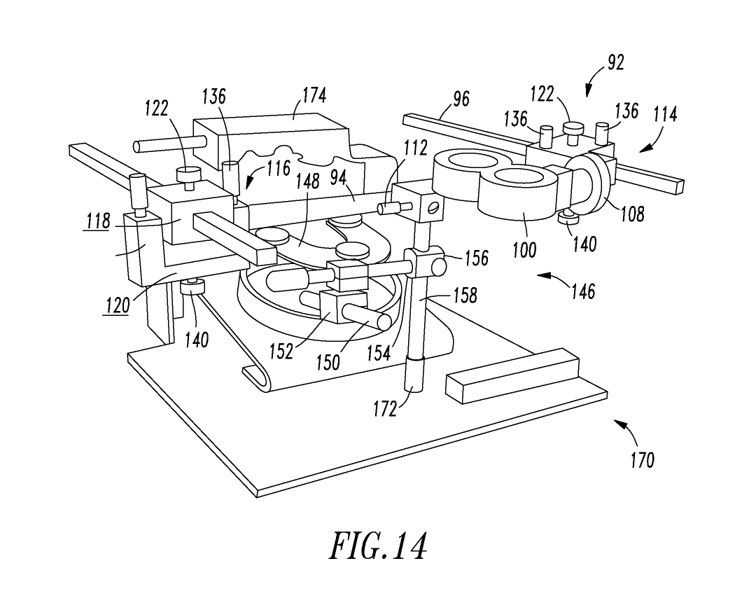

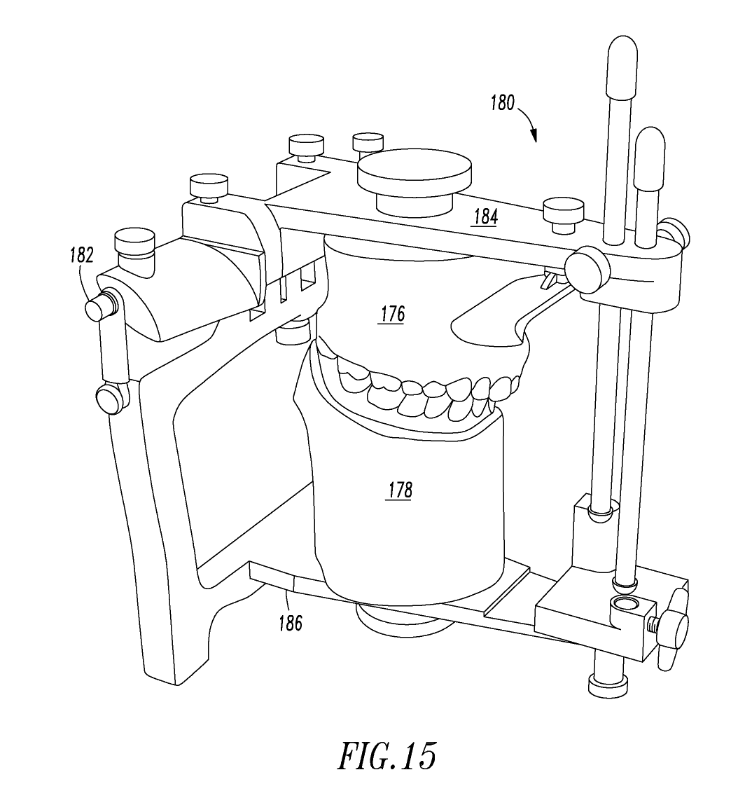

The facebow 92 and bite fork 146 are removed from the rod 24 as a single assembly, and transferred to an axis mounting stand 170 as shown in FIG. 14. Axis mounting stands are well known to those skilled in the art of orthodontics, and therefore are not described in great detail herein. Axis mounting stands that are useful with the head positioning instrument 10 are presently manufactured by Panadent, Advanced Dental Designs, and SAM. The vertical rod 158 of the bite fork 146 is vertically positioned in a location 172 on the axis mounting stand 170 designed for this purpose. The position of the assembly of the bite fork 146 and facebow 92 is then adjusted with respect to the axis mounting stand 170 so that the pointers 142, 144 of the facebow 92 are positioned adjacent to the hinge 174 of the axis mounting stand 170. Upper jaw model 176 is then positioned on the axis mounting stand 170, with its position determined by the impression compound on the mouthpiece 148 of the bite fork 146. At this point, the positions of the upper jaw model 176 with respect to the hinge axis 174 are registered.

Lastly, the upper jaw model 176 is secured in place using plaster in a manner familiar to those skilled in the art of orthodontics. The upper jaw model 176 is transferred to an articulator 180 and the lower jaw model 178 is related to the upper jaw model 176 using a centric relation wax bite. The techniques for transferring the upper jaw model 176 to the articulator 180, as well as recording the centric relation bite and mounting the lower jaw model 178 on the articulator 180, are known to those skilled in the art of orthodontics. Articulators 180 that are useful with the head positioning instrument 10 are made by Panadent, Advanced Dental Designs, and SAM. In selecting an articulator 180, it is useful to select one that is compatible with the axis mounting stand 170 being used. The upper jaw model 176 is secured to the upper member 184 of the articulator. The lower jaw model 178 is secured to the base 186 of the articulator with mounting plaster in a technique familiar to those skilled in the art of orthodontics. With the transfer of the model to the articulator 180 accomplished in this manner, the hinge 182 of the articulator 180 will be in the same position with respect to the upper jaw model 176 and lower jaw model 178 as they were with respect to the hinge 174 of the axis mounting stand 170. An accurate model of the patient's anatomy has now been produced. Pivoting the arm 184 of the articulator 180 will simulate jaw movement as it occurs within the patient. This model may be provided to a surgeon during the planning of surgery, to show both the current condition of the patient, as well as the desired changes to the patient's jaw structure. Because substantially true vertical and substantially true horizontal are represented by both the articulator and the x-ray image, and because of the accuracy with which the model was constructed utilizing the above-described procedure, the articulator and x-ray image accurately correspond to each other. The surgeon will therefore have accurate, detailed information about the surgery to be performed.

The head positioning instrument 10 therefore provides a means of accurately reproducing the jaw anatomy of a patient in a model that can be utilized for treatment planning. The location of the jaw structure with respect to a fixed point on the patient's forehead ensures that substantially true vertical and substantially true horizontal are shown in the x-ray images, and reflected in the model. The head position on the radiographs and the jaw position of the articulator mounted models of the patient's teeth are coordinated to a high level of accuracy. The result is the ability to carry out highly accurate treatment planning and execution. During actual use of the head positioning instrument 10 in planning surgery, ideal results have been reported by the surgeon performing the surgery.

A variety of modifications to the above-described embodiments will be apparent to those skilled in the art from this disclosure. Thus, the invention may be embodied in other specific forms without departing from the spirit or essential attributes thereof. The particular embodiments disclosed are meant to be illustrative only and not limiting as to the scope of the invention. The appended claims, rather than to the foregoing specification, should be referenced to indicate the scope of the invention.

1. A head positioning instrument, comprising:
a pair of reference point locators structured to locate a pair of predetermined points on a patient's head;
a lower jaw hinge locator that is structured to directly locate a lower jaw hinge; and
a bite fork structured to locate an upper jaw relative to the lower jaw hinge axis.

2. The head positioning instrument according to claim 1, further comprising a support frame structured to slidably secure the pair of reference point locators, the lower jaw hinge axis locator, and the bite fork during measurement of a patient.

3. The head positioning instrument according to claim 2, wherein the support frame is structured for adjustment so that deviation from vertical may be adjusted by a user; whereby the support frame may be positioned at substantially true vertical.

4. The head positioning instrument according to claim 3, further comprising a plurality of feet secured to a bottom of the support frame, at least two of the feet being structured to adjust towards or away from the support frame to adjust the position of the support frame relative to vertical.

5. The head positioning instrument according to claim 2, further comprising means for mounting the pair of reference point locators and lower jaw hinge locator on the support frame in a manner that permits moving the reference point locators and lower jaw hinge axis locator in a substantially vertical direction.

6. The head positioning instrument according to claim 5, wherein the means for mounting the reference point locators and lower jaw hinge axis locator comprise:
a substantially vertical rod mounted on the support frame; and
a clamp mounted to each of the reference point locators and lower jaw hinge axis locator, each clamp being structured to be secured to the substantially vertical rod.

7. The head positioning instrument according to claim 1, wherein the pair of reference point locators comprise:
a forehead locator structured to locate a predetermined point on a patient's forehead; and
a tooth locator structured to locate a tip of a front tooth relative to the predetermined point on the patient's forehead.

8. The head positioning instrument according to claim 7, wherein the forehead locator is included on a head rest.

9. The head positioning instrument according to claim 8, wherein the head rest includes a head rest body and a pair of forehead rest elements, each of the forehead rest elements being adjustable to enable movement of each rest element towards and away from the head rest body.

10. The head positioning instrument according to claim 7, wherein the tooth locator includes a gauge structured to measure a horizontal distance from a predetermined zero point.

11. The head positioning instrument according to claim 1, wherein the lower jaw hinge axis locator is a facebow.

12. The head positioning instrument according to claim 11, wherein the facebow includes a center portion defining a pair of ends, and a pair of arms, each of the arms defining a proximal end and a distal end, each of the distal ends of the facebow's arms being secured to one of the ends of the center portion, each of the facebow's arms being structured to pivot within a substantially vertical plane and to be secured at a desired angle relative to horizontal, whereby each of the facebow's arms may be set to substantially true horizontal, each of the arms further defining a hinge locator adjacent to the distal end, the hinge locator being structured to indicate a position of a patient's lower jaw hinge by being placed directly adjacent to the patient's lower jaw hinge.

13. The head positioning instrument according to claim 1, wherein the lower jaw hinge locator includes a body portion and at least one arm extending outward therefrom, the arm being structured to pivot within a substantially vertical plane and to be secured at a desired angle relative to horizontal, whereby the arm may be set to substantially true horizontal, the arm including a hinge locator, the hinge locator being structured to indicate a position of a patient's lower jaw hinge by being placed directly adjacent to the patient's lower jaw hinge.

14. The head positioning instrument according to claim 1, wherein the lower jaw hinge locator includes an attachment means for securing the bite fork.

15. The head positioning instrument according to claim 1, wherein the bite fork comprises:
a generally U-shaped portion structured to fit within a patient's mouth;
a mounting portion structured to be secured to the lower jaw hinge locator; and
adjustment means for adjusting a vertical position and horizontal position of the generally U-shaped portion with respect to the mounting portion.

16. The head positioning instrument according to claim 15, wherein the means for adjusting a vertical position and horizontal position of the generally U-shaped portion of the bite fork with respect to the mounting portion of the bite fork comprise:
a first rod extending between the generally U-shaped portion and a first claiming mechanism, the first rod being slidably secured within the first clamping mechanism;
a second rod extending from the first clamping mechanism to a second clamping mechanism, the second rod being slidably secured within the first clamping mechanism and the second clamping mechanism; and
a third rod slidably secured within the second clamping mechanism, the third rod defining the mounting portion thereon.

17. A method of representing a facial anatomy of a patient, the method comprising:
identifying a first predetermined point on a patient's head, the first predetermined point being easily discernable on an x-ray image;
identifying a second predetermined point on a patient's head, the second predetermined point being easily discernable on an x-ray image;
measuring a horizontal distance between the first and second predetermined points;
providing an indication of substantially true vertical and substantially true horizontal in a manner which will appear on an x-ray image; and
taking an x-ray image of the patient's head.

18. The method according to claim 17, further comprising:
establishing a location of a position of a hinge of a lower jaw of a patient, and directly indicating the location of the lower jaw hinge the hinge using a lower jaw hinge locator;
providing a bite fork, the bite fork being structured to be secured to the lower jaw hinge locator;
securing the bite fork to the lower jaw hinge locator;
utilizing the bite fork to locate a position of an upper jaw relative to the hinge of the lower jaw;
mounting the lower jaw hinge locator on an axis mounting stand;
positioning the lower jaw hinge locator adjacent to a hinge defined on the axis mounting stand; and
positioning an upper jaw model against the bite fork.

19. A method of modeling a facial anatomy of a patient, the method comprising:
establishing a location of a position of a hinge of a lower jaw of a patient, and directly indicating the location of the lower jaw hinge the hinge using a lower jaw hinge locator;
providing a bite fork, the bite fork being structured to be secured to the lower jaw hinge locator;
securing the bite fork to the lower jaw hinge locator;
utilizing the bite fork to locate a position of an upper jaw relative to the hinge of the lower jaw;
mounting the lower jaw hinge locator on an axis mounting stand;
positioning the lower jaw hinge locator adjacent to a hinge defined on the axis mounting stand; and
positioning an upper jaw model against the bite fork.
